(19) United States
(12) Patent Application Publication
(10) Pub. No.: US 2005/0210652 A1
(43) Pub. Date: Sep. 29, 2005

(54) Oral motor therapy device

(76) Inventor: Lynn Epstein, Laguna Beach, CA (US)

Correspondence Address: KING & SPALDING, 191 Peachtree Street, Atlanta, GA, 30303, US

(21) Appl. No.: 10/807,713

(22) Filed: Mar. 23, 2004

(51) Int. Cl. A61H 7/00; A61H 19/00; G09B 17/00; B21D 39/02

(52) U.S. Cl. 29/463; 2/21

(57) ABSTRACT

The present invention includes a device having a plurality of connected finger covers. The finger covers are preferably configured to be worn by a user around at least two of the user's fingers. The device also preferably has at least two sets of protrusions. Each set of protrusions is preferably connected to a finger cover and is configured to provide a different tactile sensation from the other set of protrusions. With the device of the present invention, the user may switch between the two sets of protrusions when providing tactile sensation to a person by moving the finger to which the desired set of protrusions is connected.

### CROSS REFERENCE TO RELATED APPLICATIONS

None

### FIELD OF INVENTION

The present invention relates to medical devices used for therapy, particularly mechanical devices used for oral motor therapy.

### BACKGROUND

Oral motor therapy or oral sensory-motor therapy is generally conducted to facilitate improved oral functions for eating, drinking and speaking. The oral functions include strength, coordination, and reception of oral sensory stimulation. Achieving normal sensitivity within the oral cavity, achieving normal muscle substance, and exhibiting controlled sequenced movements are critical for the development of normal speaking and feeding skills. For instance, hyposensitivity or decreased sensitivity of the oral tactile system can interfere with a child's ability to tolerate new food textures and to participate in exploratory play involving the mouth. It has been shown that there is a negative effect on the acquisition of normal feeding and oral speech movements when a child is unable to engage in mouthing activities.

Muscle substance is another critical factor for obtaining normal speaking skills. For instance, a low tone in a child's face often interferes with the child's ability to develop tension and coordinate sequenced movements of the lips, tongue, and jaw. Coordinated sequenced movements of the lips, tongue, and jaw are important in developing speaking, chewing, and swallowing skills. For instance, lack of coordinated sequenced movements of the lips, tongue, and jaw can cause speech intelligibility because fine movements necessary for refined speech are products of coordinated sequenced movements of the lips, tongue, and jaw.

Oral motor therapy may generally be useful for infants, children, and adults experiencing feeding or motor speech difficulties, such as developmental speech or language delay, autism, and speech difficulties caused by learning disability, neurological impairment, and traumatic injury. Oral motor therapy is geared to remedy deficits in the areas of feeding, speech production, articulation, and phonology. Oral motor therapy also seeks to remedy motor speech disorders, such as apraxia and dyspraxia. Oral motor awareness, reduction and elimination of drooling, and regulating oral sensitivity and self-monitoring skills are targeted as well. For general information regarding oral motor therapy, please refer to “Oral-Motor Techniques in Articulation Therapy, A Two-Day Videotape Workshop, Pamela Rosenwinkel Marshalla, MA, CCC-SLP, Speech-Language Pathologist, 1992,” and “Great Therapy Ideas, Oral Sensory-Motor Tool-Toys Techniques, Boshart et al., 2000.” Both publications are incorporated herein by reference.

In oral motor therapy, therapists often use tactile sense input, such as light touch, deep touch, texture, and temperature variations, to develop the physiological capacity necessary for eating skills and speech production. Therapists use a variety of tools to provide tactile sensory input. Therapists also use tools to enhance oral sensory-motor therapy, to facilitate oral airflow and oral coordination, to facilitate oral experimentation and mouthing, and to promote tactile alertness and deep muscle stimulation.

Examples of the tools therapists' use include the device disclosed in U.S. Pat. No. 5,735,772. The device in '772 consists of an elongated biting tube and a handle that may be manipulated from the external of the mouth. The device in '772 is used to rehabilitate a child's jaws. Therapists also use the device disclosed in U.S. Pat. No. 6,669,657 to provide deep pressure and frictional rubbing to a patient's skin. Finally, therapists commonly use a NUK massage brush (NUK is a trademark owned by Mapa GmbH, Gummi-und Plastikwerke, Zeven, Germany). The NUK massage brush consists of a handle and a cylindrical end. The cylindrical end consists of knobs and is used to massage portions of a person's oral cavity, such as the gums, to help apply teething gel, and to provide deep intraoral compression. It is common for therapists to use a plurality of tools in a single therapy session. For instance, therapists may have to experiment with a plurality of tools to find the tool that may work for a particular child for a given moment.

Existing oral motor therapy devices and techniques require a plurality of tools to be inserted in a child's mouth one-by-one. Each time a therapist removes a tool and introduces a different tool, the therapist may be met with resistance from the child. The therapist may have to exert time, effort, and patience in persuading the child to open his mouth and allow the therapist to insert a different tool. The more therapists insert and remove a tool from a child's mouth, the more anxiety the child will likely experience. Thus, a long felt but unmet need exists for children for a device that would reduce the number of times a new tool is introduced into a child's mouth.

Next, with existing oral motor therapy tools and techniques, therapists have to stop and spend some time changing one tool for another. Therapists may have to spend additional time to look for a particular tool. The time spent to change tools may mean lost opportunity to treat a child who is in a desirable mood. Long transitions can also hamper effects of massage. A long felt but unmet need exists for a device that reduces the amount of time it currently takes therapists to change tools.

### BRIEF DESCRIPTION

The present invention includes a device having a plurality of connected finger covers. The finger covers are preferably configured to be worn by a user around at least two of the user's fingers. The device also preferably has at least two sets of protrusions. Each set of protrusions is preferably connected to a finger cover and is configured to provide a different tactile sensation from the other set of protrusions. With the device of the present invention, the user may switch between the two sets of protrusions when providing tactile sensation to a person by moving the finger to which the desired set of protrusions is connected. The set of protrusions may be a plurality of spikes, a plurality of knobs, a plurality of concentric rings, a plurality of curved lines, or a combination of any of the above protrusion types.

The present invention also includes a method for providing stimulus to a person. The method includes providing a covering for a first finger; providing a first tool connected to the first finger covering, the first tool being configured to be used by moving the finger covered by the first finger covering; providing a second finger covering; providing a second tool connected to the second finger covering, the second tool being configured to be used by moving the finger covered by the second finger covering; covering the first finger; covering the second finger; placing at least one portion of the covered first finger in contact with a person's body part; moving the covered first finger; and switching from using the first tool to using the second tool by moving the finger covered by the second finger covering and placing at least one portion of the covered second finger in contact with the person's body part. The body part may be a human being's face, lips, cheeks, tongue, palate, throat, or neck.

The above description sets forth, rather broadly, a summary of certain embodiments of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a front elevational view of one embodiment of the oral motor therapy device of the present invention.

### DETAILED DESCRIPTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

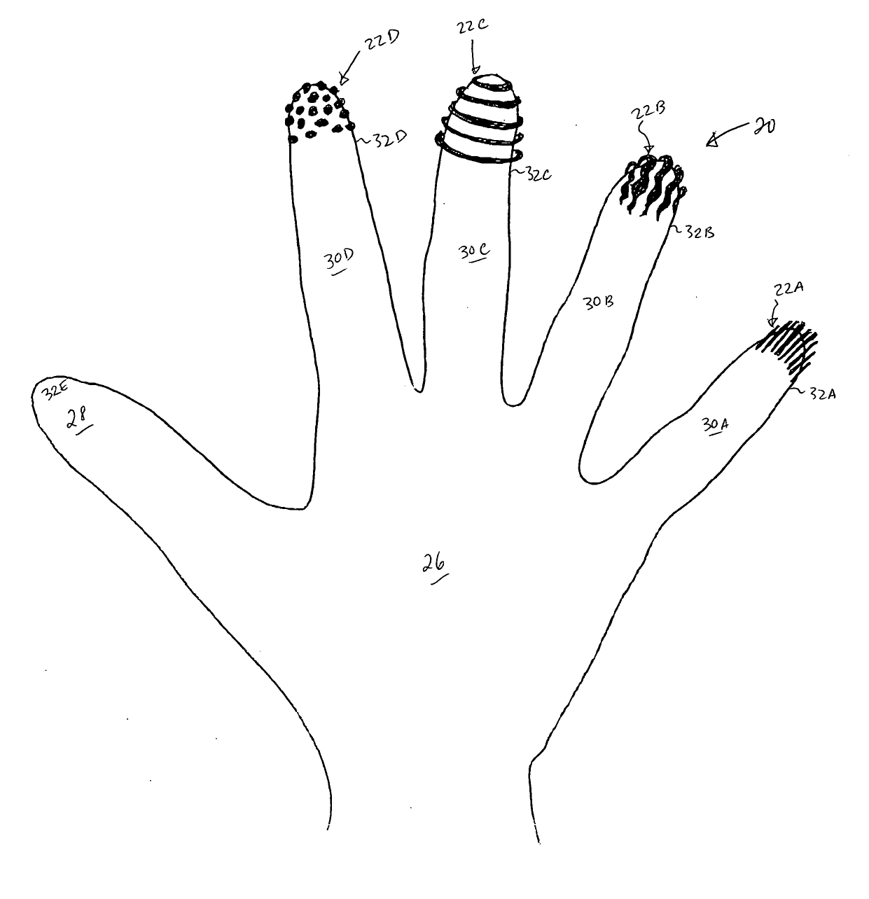

The present invention comprises an oral motor therapy device, generally indicated by reference number 20. Referring to FIG. 1, the oral motor therapy device 20 preferably is in a form of a glove. As used herein, the term “glove” may interchangeably be used with the terms “mitt” or “mitten” to refer to a covering for the hand having separate sections for at least some of the fingers or the thumb. It is noted that the oral motor therapy device 20 may exist in other forms, such as a partial glove or a glove with some of the finger coverings being cut out.

Oral motor therapy device 20 preferably includes a hand area covering 26, a thumb area covering 28, finger area covering 30A-D, fingertip area covering 32A-D, and a palm area covering (not shown in FIG. 1). Each fingertip area covering 32A-D preferably has a set of protrusions 22A-D. The fingertip area covering for the thumb 32E preferably does not have a set of protrusions. However, a set of protrusions may be provided on fingertip are 32E, if desired.

The set of protrusions on each fingertip area covering is preferably different. For instance, as shown in FIG. 1, the set of protrusion 22A on the fingertip area covering 32A for the index finger is preferably a plurality of spikes. The spikes are preferably formed from the same material as the oral motor device 20 when the oral motor device 20 is created by a molding process. The spikes may be made of plastic bristles or other materials known in the art.

The set of protrusion 22B on fingertip area covering 32B for the ring finger is preferably a plurality of curved lines. The set of protrusion 22C on fingertip area covering 32C for the middle finger is preferably a plurality of concentric rings wrapped around the fingertip area 32C. The set of protrusion 22D on fingertip area covering 32D for the index finger is preferably a plurality of semi-circular structures or knobs.

The assignments of the sets of protrusions on their respective fingertip area coverings may be interchanged. For instance, the fingertip area covering for the middle finger 32C may have a plurality of spikes, and the fingertip area covering for the ring finger 32B may have a plurality of concentric rings. The shapes, sizes, and arrangements of the protrusions may also vary. In an alternative embodiment, a set of protrusions may be a mixture of various protrusion types. For instance, the fingertip area covering for the middle finger 32C may be designed with a combination of concentric rings and knobs.

It can be appreciated that each set of protrusions connected to a fingertip area covering provides an individual oral motor therapy device. To illustrate, a therapist may cause the finger being covered by fingertip area 32B (the ring finger) to come in contact with a patient's face. The corresponding set of protrusion 22B thus serves as an oral motor therapy device in that it is used to provide tactile stimulus to the patient.

It can further be appreciated that oral motor device 20 provides a collection of oral motor therapy devices that are easily switchable. For instance, the therapist, who is using the set of protrusions 22B to provide stimulus to a patient's face, may decide to use a different set of protrusion to stimulate the patient's tongue, such as set of protrusions 22C. The therapist may simply move the finger being covered by a fingertip area covering 32C (the middle finger) and cause the fingertip area covering 32C to come in contact with the patient's tongue.

The oral motor therapy device 20 may be made of latex, rubber, vinyl, or other glove materials known in the art. Oral motor therapy device 20 may further be made with non-latex materials for users who are allergic to latex. Oral motor therapy device 20 may be made by molding processes or polymerization processes known in the art. For instance, a mold may be made having portions that will form the hand area covering 26, the thumb area covering 28, the finger area coverings 30A-D, fingertip area coverings 32A-D, and the palm area covering. The mold may also be designed to form the desired sets of protrusions for some or all of the fingertips.

Once a mold is made, choice monomers and polymerization catalyst that are known in the art may be used as raw materials. The conventional polymerization process steps of allowing the polymer to cure and cool may be performed. In an alternative embodiment, the sets of protrusions may be attached to pre-existing gloves using glue or fasteners or attachment techniques known in the art.

Oral motor therapy device 20 is preferably sterilized using sterilization methods known in the art. Alternatively, oral motor therapy device 20 may be sterilized before use, such as by spraying or applying a sterilizing agent commonly known in the art. Artificial flavors or scents may be added on to the oral motor therapy device 20. For instance, artificial flavors or scents may be mixed with the raw materials. Alternatively, artificial flavors or scents may be sprayed or poured onto the oral motor therapy device 20. To provide ease for the user in wearing the oral motor therapy device 20, the device may be powdered. The oral motor therapy device 20 is also preferably made of polymers known to be dishwasher safe and able to withstand sterilization process.

Manner of Use

Oral motor therapy device 20 is preferably configured to be used in the following manner. The user preferably first wears the oral motor therapy device 20 on his hand. The user then causes a set of protrusions 22A, 22B, 22C, or 22D to come in contact with a patient's face. The user may apply a light to medium press-action or a series of rhythmic or patterned light taps or vibrations onto the cheeks or the lips. The user may also move his finger around the patient's face 34 in a sliding manner to provide stimulus to the patient. The user may switch from using one set of protrusions to another.

The user may cause a set of protrusion 22A, 22B, 22C, or 22D to come in contact with an area of the patient's tongue. The type of contact may be a press and release action, compression, a light touch, or light movement. Rubbing is preferably avoided. The user may switch from using one set of protrusions to another by switching to the finger that has the desired set of protrusions. The user may switch until the user identifies the set of protrusions that generates the desired response.

The user may provide stimulus to various areas of the patient's tongue to help the patient develop differentiation skills. Differentiation skills may include the ability to recognize which area of the tongue is being stimulated. The user may also use the oral motor therapy device 20 to stimulate the back of the tongue of the patient to increase its sensitivity. Difficulty in producing /k/ /g/ or /r/ is often traced to a lack of sensitivity on the back of the tongue. Oral motor therapy device 20 may further be used to stimulate a portion of a person's oral cavity, such as a side of a mouth or a person's palate. The user may adapt the use of the oral motor therapy device 20 with existing oral motor therapy techniques.

It can thus now be appreciated that certain embodiments of the present inventions provide oral motor therapists with a tool for producing tactile sense input to their patients. The tool embodies a plurality of useful tools that are attached to one easily accessible location. Thus, during a therapy session, the therapist can easily switch from one tool to another without spending a substantial amount of time. Because of the minimal time incurred in between tools, the effects of massage are maximized and the mood of a child being treated may likely be maintained.

With certain embodiments of the present invention, the therapists are able to switch tools while still using one tool or while the patient's mouth is still open. This feature helps minimizes anxiety in children, as children are prone to becoming anxious each time a tool is inserted and removed from their mouths. The therapist may further be provided with sterilized tools each time the therapist uses the oral motor therapy device 20 of the present invention, as the oral motor therapy device 20 may be made of disposable and sterile materials.

Although the description above contains many specifications, these should not be construed as limiting the scope of the invention but as merely providing illustrations of some of presently preferred embodiments of this invention. For instance, the number of fingers being covered by the oral motor therapy device 20 may vary. The shapes, sizes, and positions of the protrusions may also vary. Thus, the scope of the invention should be determined by the appended claims and their legal equivalents rather than by the examples given.

1. A device comprising:
(A) a first finger covering, the first finger covering being configured to cover a first finger;
(B) a second finger covering, the second finger covering being configured to cover a second finger;
(C) a first tool connected to the first finger covering, the first tool being configured to be used by moving the finger covered by the first finger covering; and
(D) a second tool connected to the second finger covering, the second tool being configured to be used by moving the finger covered by the second finger covering, wherein the user may switch from using the first tool to using the second tool by moving the finger covered by the second finger covering.

2. The device of claim 1, wherein the first or the second tool comprises a plurality of spikes.

3. The device of claim 1, wherein the first or the second tool comprises a plurality of knobs.

4. The device of claim 1, wherein the first or the second tool comprises a plurality of concentric rings.

5. The device of claim 1, wherein the first or the second tool comprises a plurality of curved lines.

6. A device comprising:
(A) a plurality of connected finger covers, the finger covers being configured to be worn by a user around at least two of the user's fingers; and
(B) at least two sets of protrusions, each set of protrusions being connected to a finger cover, each set of protrusions being configured to provide a different tactile sensation from the other set of protrusions, wherein the user may switch between the two sets of protrusions when providing tactile sensation to a person by moving the finger to which the desired set of protrusions is connected.

7. The device of claim 6, wherein at least one set of protrusions comprises a plurality of spikes.

8. The device of claim 6, wherein at least one set of protrusions comprises a plurality of knobs.

9. The device of claim 6, wherein at least one set of protrusions comprises a plurality of concentric rings.

10. The device of claim 6, wherein at least one set of protrusions comprises a plurality of curved lines.

11. The device of claim 6, wherein the device is configured to be used for oral motor therapy.

12. A method for providing stimulus to a person, the method comprising:
(A) providing a covering for a first finger;
(B) providing a first tool connected to the first finger covering, the first tool being configured to be used by moving the finger covered by the first finger covering;
(C) providing a second finger covering;
(D) providing a second tool connected to the second finger covering, the second tool being configured to be used by moving the finger covered by the second finger covering;
(E) covering the first finger;
(F) covering the second finger; and
(G) placing at least one portion of the covered first finger in contact with a person's body part;
(H) moving the covered first finger; and
(I) switching from using the first tool to using the second tool by moving the finger covered by the second finger covering and placing at least one portion of the covered second finger in contact with the person's body part.

13. The method of claim 12, wherein the body part is a human being's face.

14. The method of claim 12, wherein the body part is a human being's lips.

15. The method of claim 12, wherein the body part is a human being's cheeks.

16. The method of claim 12, wherein the body part is a human being's tongue.

17. The method of claim 12, wherein the body part is a human being's palate.

18. The method of claim 12, wherein the body part is a human being's throat.

19. The method of claim 12, wherein the body part is a human being's neck.

20. The method of claim 12, further providing a glove, the first finger covering and the second finger covering forming a portion of the glove.

21. A device comprising:
(A) a first cover means for substantially covering a first finger of a user;
(B) a second cover means for substantially covering a second finger of a user, the first and the second cover means being connected to each other;
(C) a first stimulating means for providing tactile sensation to a person, the first stimulating means being connected to the first cover means; and
(D) a second stimulating means for providing tactile sensation to a person, the second stimulating means being connected to the second cover means, wherein the first stimulating means is configured to provide a different tactile sensation from the second stimulating means, wherein the user may switch between the two sets of stimulating means.

22. The device of claim 21, wherein the first or the second stimulating means comprises a plurality of spikes.

23. The device of claim 21, wherein the first or the second stimulating means comprises a plurality of knobs.

24. The device of claim 21, wherein the first or the second stimulating means comprises a plurality of concentric rings.

25. The device of claim 21, wherein the first or the second stimulating means comprises a plurality of curved lines.

26. The device of claim 21, wherein the first and the second cover means forms a part of a glove.

27. The device of claim 21, wherein the device is configured to be used for oral motor therapy.

28. The device of claim 1, wherein the device is configured to be used for oral motor therapy.

29. The device of claim 1, further comprising a glove, the first finger covering and the second finger covering forming a portion of the glove.
